(19) United States
(12) Patent Application Publication
(10) Pub. No.: US 2008/0016077 A1
(43) Pub. Date: Jan. 17, 2008

(54) A SYSTEM FOR ENSURING THAT ONLY ONE COMPUTER APPLICATION MAINTAINS EDIT OR DELETE ACCESS TO A FILE AT ALL TIMES

(75) Inventors: Sandy Kao, Austin, TX (US); Arif Kasim, San Antonio, TX (US); Rodrigo Pastrana, Delray Beach, FL (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/456,619

(22) Filed: Jul. 11, 2006

(51) Int. Cl. G06F 17/30

(52) U.S. Cl. 707/9

(57) ABSTRACT

An operating system providing a service application that prevents the malicious alteration and deletion of computer files. The system including a computer configured to store a plurality of files in a mass storage sector on the computer. A plurality of computer applications operable with the computer are stored in the mass storage sector. A service application is operably associated with the operating system. The service application is configured to protect a set of files from malicious alteration and deletion. The set of files are selected from the plurality of files. The service application receives the following information, (i) target file name, (ii) process name, and (iii) file access permission, to set up protection for the set of files. The service application securely maintains the information in the mass storage sector.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to computers, and more particularly, to limiting access to computer files.

2. Description of Background

Computers are used on a daily basis in various environments. For example, it is common in work environments, academic environments and home environments to use a computer to perform high speed mathematical or logical operations or to assemble, store, correlate or process information quickly. The versatility of a computer makes it a very useful tool for the average computer user.

Yet, there are flaws with all computers. One flaw includes the fact that computer files can easily be tampered with by a computer user. At times the computer user may become agitated and/or hostile and the computer user may maliciously edit or delete important computer files, which could lead to data corruption. For example, it is a customary practice for employers to escort a terminated or laid-off employee from the work premises to ensure that the displaced employee does not destroy or alter the contents of important computer files.

Another common solution to prohibiting tampering with the contents of an important computer file is to make the computer file a read-only file. Yet, making a computer file a read-only file is an attribute that can easily be changed to allow complete access to the contents of the file by anyone.

Thus, there is a need to limit access to a computer file such that an unauthorized user or unauthorized application cannot delete or edit the contents of the computer file.

### SUMMARY OF THE INVENTION

The shortcomings of the prior art are overcome and additional advantages are provided through the provision of an operating system providing a service application that prevents the malicious alteration and deletion of computer files. The system includes a computer configured to store a plurality of files in a mass storage sector on the computer. The system further includes a plurality of computer applications operable with the computer and stored in the mass storage sector. The system further includes a service application operably associated with the operating system, the service application configured to protect a set of files from malicious alteration and deletion, such set of files being selected from the plurality of file. The service application receives the following information, (i) target file name, (ii) process name, and (iii) file access permission, to set up protection for the set of files, the service application securely maintains the information in the mass storage sector.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for an operating system providing a service application that prevents the malicious alteration and deletion of computer files.

### BRIEF DESCRIPTION OF THE DRAWINGS

The subject matter, which is regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a computer system;

FIG. 2 illustrates one example of a plurality of files stored on the computer system of FIG. 1; and

FIG. 3 illustrates one example of a plurality of computer applications stored on the computer system of FIGS. 1 and 2.

The detailed description explains the preferred embodiments of the invention, together with advantages and features, by way of example with reference to the drawings.

### DETAILED DESCRIPTION OF THE INVENTION

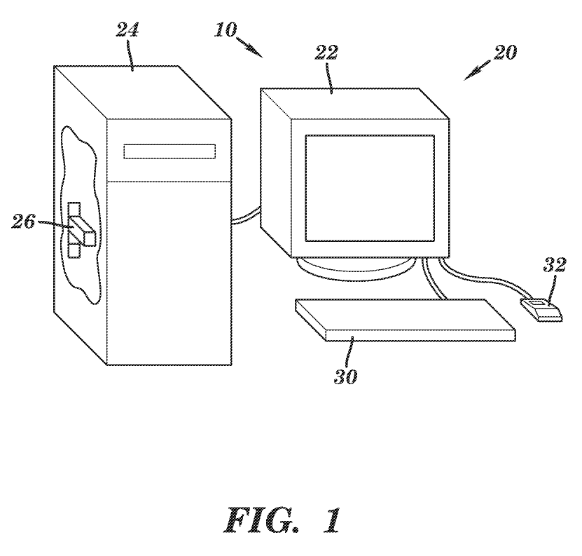

Referring to FIG. 1, an operating system 10 providing a service application that prevents the malicious alteration and deletion of computer files, is shown. The operating system 10 executes on a computer 20. As well known in the art, the computer 20 is a programmable electronic device that performs high-speed mathematical or logical operations or assembles, stores, correlates or processes information.

The computer 20 includes a monitor 22, the monitor 22 accepts video signals representing information from the computer 20 and displays the information represented by the video signals on the monitor 22. The computer 20 further includes a central processing unit 24, which interprets and executes instructions. The monitor 22 is operably coupled to the central processing unit 24. The computer 20 further includes a mass storage sector 26 (e.g., hard drive, RAM). The mass storage sector 26 is the portion of the computer 20 that is configured for storing and preserving data for later retrieval. Further included with the computer 20 are a keyboard 30 and a mouse 32. The keyboard is operably coupled to the central processing unit 24 and used to enter text or data into the computer 20, the entered text and data is displayed on the monitor 22. The mouse 32 is a hand-held button activated input device that controls the movement of an indicator displayed on the monitor 22. The mouse 32 allows the user of the system to select operations or manipulate text or graphics associated with the computer 20. Similar to the keyboard 30, the mouse 32 is operably coupled to the central processing unit 24.

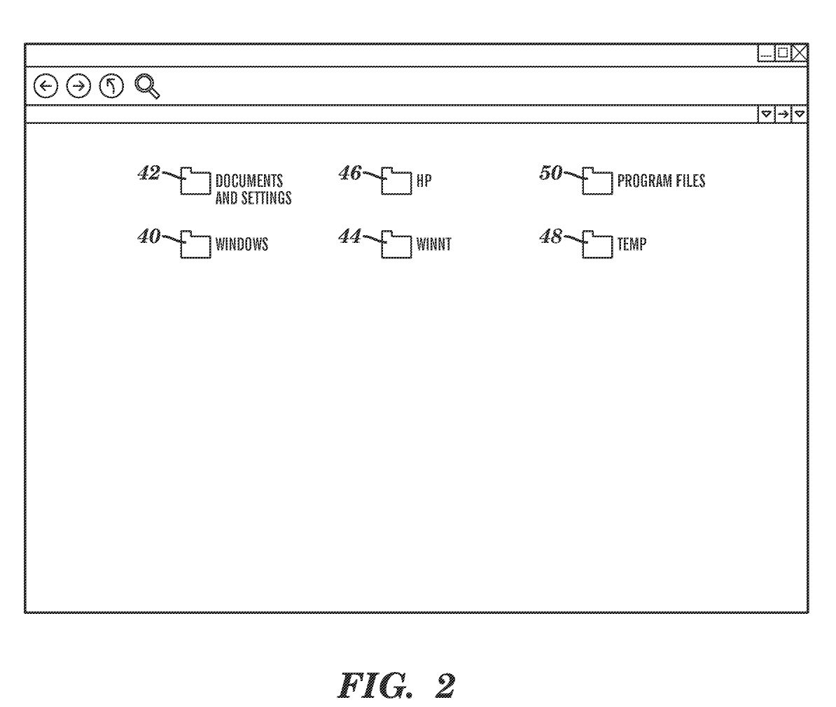

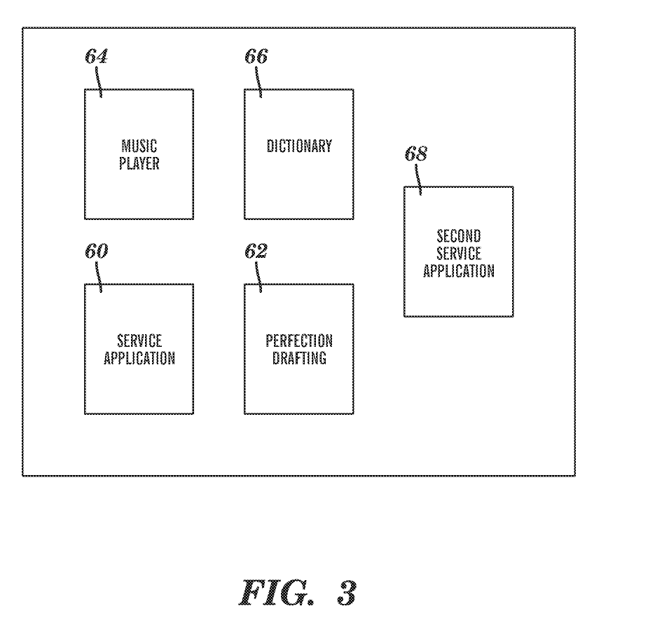

Referring to FIGS. 2 and 3, the computer 20 is configured to store a plurality of files 40, 42, 44, 46, 48 and 50 in the mass storage sector 26. Furthermore, a plurality of computer applications 60, 62, 64, 66 and 68 are operable with the computer 20 and are also stored in the mass storage sector 26. One of the applications is a service application 60, which is configured to protect a set of files from malicious alteration and deletion. The protected files are selected from the plurality of files 40, 42, 44, 46, 48 and 50 in the mass storage sector. An application may request the service application 60 to protect files. In order to protect the files, the service application 60 obtains the following information, (i) target file name, (ii) process name, and (iii) file access permission from the application to set up protection for the set of files. The system 10 securely maintains the information in the mass storage sector 26.

The target file name is the name of the file to be protected. The process name is the name of the processes (applications and users) to be given file access. The file access permission is the level of access granted to the processes (applications and users). The file access permission is governed by at least one of the following rules of access, (a) manage, (b) write, (c) delete, and (d) write and delete. File access permissions on a particular file can be altered at any point by any user with manage permission set on that file, or by any trusted application if the file does not have any access restrictions. The user or an application having write permission set on the file may add content by writing to the file. Delete permission allows the user or an application to have deletion capabilities with the particular file. The service application 60 is configured to enforce the file rules of access.

The service application 60 may be configured to re-initiate when an unauthorized user attempts to disable the service application 60. Furthermore, the service application 60 may be configured to initiate a second service application 68 when an unauthorized user attempts to disable the original service application 60, such that the second service application 68 protects the set of files from malicious alteration and deletion.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An operating system providing a service application that prevents the malicious alteration and deletion of computer files, comprising:
a computer configured to store a plurality of files in a mass storage sector on the computer;
a plurality of computer applications operable with the computer and stored in the mass storage sector; and
the service application operably associated with the operating system, the service application configured to protect a set of files from malicious alteration and deletion, the set of files being selected from the plurality of files;
Wherein the service application receives the following information, (i) target file name, (ii) process name, and (iii) file access permission, to set up protection for the set of files, the system securely maintains the information in the mass storage sector.

2. The system of claim 1, wherein (i) target file name is the name of the file to be protected.

3. The system of claim 2, wherein (ii) process name is the name of the processes to be given file access.

4. The system of claim 3, wherein file access permission is the level of access granted to the processes, such file access permission being governed by at least one of the following rules of access, (a) manage, (b) write, (c) delete, and (d) write and delete.

5. The system of claim 4, the service application being configured to enforce the file rules of access.

6. The system of claim 5, wherein the service application is configured to re-initiate when an unauthorized user attempts to disable the service application.

7. The system of claim 5, wherein the service application is configured to initiate a second service application when an unauthorized user attempts to disable the original service application, such that the second service application protects the set of files from malicious alteration and deletion.
